(19) United States
(12) Patent Application Publication
(10) Pub. No.: US 2012/0146854 A1
(43) Pub. Date: Jun. 14, 2012

(54) ANTENNA DEVICE

(75) Inventor: Shohei ISHIKAWA, Kawasaki (JP)

(73) Assignee: FUJITSU LIMITED, Kawasaki-shi (JP)

(21) Appl. No.: 13/185,141

(22) Filed: Jul. 18, 2011

(30) Foreign Application Priority Data
Dec. 10, 2010 (JP) 2010-276320

(51) Int. Cl. H01Q 9/04

(52) U.S. Cl. 343/700 MS

(57) ABSTRACT

An antenna device includes a ground plate, a feed section insulated from the ground plate, two radiating conductors each coupled to a corresponding short-circuit section coupled to the feed section and the ground plate, extending in parallel to the ground plate, and spaced a predetermined distance apart from the ground plate; and a feeder circuit that supplies electric power to the radiating conductors, the two radiating conductors are disposed, on the ground plate, at positions symmetric about the midpoint of the ground plate, the feeder circuit supplies electric power in opposite phases to the two radiating conductors, and the two radiating conductors have bent portions of the same form.

### CROSS-REFERENCE TO RELATED APPLICATIONS

This application is based upon and claims the benefit of priority of the prior Japanese Patent Application No. 2010-276320, filed on Dec. 10, 2010, the entire contents of which are incorporated herein by reference.

### FIELD

The embodiments discussed herein are related to an antenna device of a radio communication device.

### BACKGROUND

Radio Frequency Identification (RFID) is an automatic recognition system that reads and writes specific information on people or an object stored in a medium called an RFID tag through radio communication with a radio communication device called a reader/writer (R/W). The reading/writing includes calling, entering, deleting, and updating of data. For an antenna at an RFID tag side, a linearly polarized antenna is often used. Therefore, a circularly polarized antenna is used as an antenna at a reader/writer (R/W) side to allow transmission and reception even if any direction the RFID tag faces.

### SUMMARY

According to an aspect of the embodiment, an antenna device includes a ground plate, a feed section insulated from the ground plate, two radiating conductors each coupled to a corresponding short-circuit section coupled to the feed section and the ground plate, extending in parallel to the ground plate, and spaced a predetermined distance apart from the ground plate; and a feeder circuit that supplies electric power to the radiating conductors, the two radiating conductors are disposed, on the ground plate, at positions symmetric about the midpoint of the ground plate, the feeder circuit supplies electric power in opposite phases to the two radiating conductors, and the two radiating conductors have bent portions of the same form.

The object and advantages of the embodiment will be realized and attained by at least the features, elements, and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram showing an example of an antenna device of a configuration example 1-1.

FIG. 2 is a diagram of an example of a plane of the antenna device intersecting a ground plate at right angles and including a grounding point.

FIG. 3 is a diagram of the antenna device as viewed from the Z-axis direction.

FIG. 4 is a diagram showing an example of the value of a length b1 relative to a length a1 at which the axial ratio of the antenna device is the minimum.

FIG. 5 is a diagram showing an example of a graph of the antenna axial ratio at a frequency of 950 MHz.

FIG. 6 is a diagram showing an example of an antenna device of a configuration example 1-2.

FIG. 7 is a diagram showing an example of the value of the length b1 relative to the length a1 at which the antenna axial ratio is the minimum.

FIG. 8 is a diagram showing an example of a graph of the antenna axial ratio at a frequency of 950 MHz.

FIG. 9 is a diagram showing an example of an antenna device of a configuration example 2-1.

FIG. 10 is a diagram showing an example of an antenna device of a configuration example 3-1.

FIG. 11 is a diagram of the antenna device as viewed from the Z-axis direction.

FIG. 12 is a diagram showing an example of an antenna device of a configuration example 4-1.

FIG. 13 is a diagram of the antenna device as viewed from the Z-axis direction.

FIG. 14 is a diagram showing an example of an antenna device of a configuration example 5-1.

FIG. 15 is a diagram showing an example of the cross section of a dielectric portion and a first conductor.

FIG. 16 is a diagram showing an example of an antenna device of a configuration example 6-1.

FIG. 17 is a diagram for explaining a feeder circuit coupled to the antenna device 600.

FIG. 18 is a diagram showing an example of a gain in the X-Z plane of the antenna device of the first embodiment.

FIG. 19 is a diagram showing an example of a gain in the X-Z plane of the antenna device of the sixth embodiment.

### DESCRIPTION OF EMBODIMENTS

Radio communication devices are becoming smaller in size. Circularly polarized antennas installed in the housings of radio communication devices are also required to be small. However, antennas having a circular polarization characteristic, such as a patch antenna, a helical antenna, and a cross dipole antenna, are difficult to reduce in size. Although an inverted-F antenna is easy to reduce in size, it is a linear polarization antenna. Therefore, the inverted-F antenna is difficult to use in a radio communication device that uses a circularly polarized antenna.

The device disclosed is an antenna device having a circular polarization characteristic.

The device disclosed adopts the following solutions to solve the problems described above.

A first aspect is an antenna device comprising a ground plate; a feed section insulated from the ground plate; two radiating conductors each coupled to a corresponding short-circuit section coupled to the feed section and the ground plate, extending in parallel to the ground plate, and spaced a predetermined distance apart from the ground plate; and a feeder circuit that supplies electric power to the radiating conductors, the two radiating conductors are disposed, on the ground plate, at positions symmetric about the midpoint of the ground plate; the feeder circuit supplies electric power in opposite phases to the two radiating conductors; and the two radiating conductors have bent portions of the same form.

According to an embodiment disclosed herein, an antenna device having a circular polarization characteristic can be provided.

Embodiments will be described hereinbelow with reference to the drawings. It is to be understood that the configurations of the embodiments are merely examples and are not limited thereto.

### First Embodiment

### Configuration Example 1-1

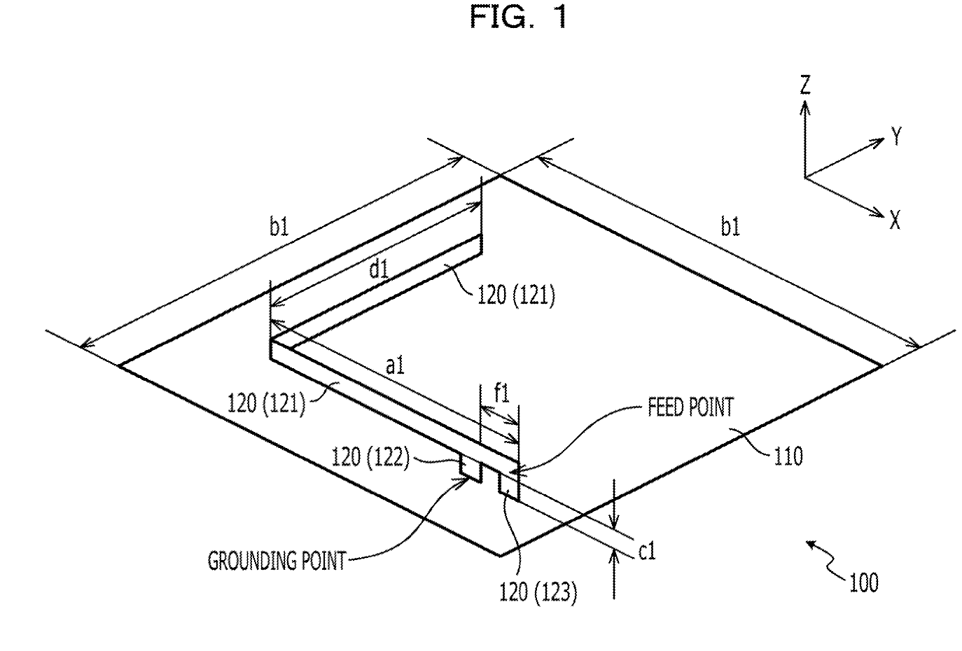

FIG. 1 is a diagram showing an example of an antenna device of a configuration example 1-1. An antenna device 100 includes a ground plate 110 and a radiating conductor 120.

The ground plate 110 is a flat square with a length b1 on each side. Examples of the material of the ground plate 110 include metal, such as aluminum and copper. The thickness of the ground plate 110 may be, for example, 2 mm, to maintain the flatness; however, it is not limited thereto. The ground plate 110 may be bonded to a dielectric on a flat plate.

The radiating conductor 120 includes a first conductor 121, a second conductor 122, and a third conductor 123. The first conductor 121 and the second conductor 122 are in electrical contact with each other. The first conductor and the third conductor 123 are electrically coupled to each other. The radiating conductor 120 receives a signal sent from a feeder circuit. The first conductor 121, the second conductor 122, and the third conductor 123 can be formed as one member.

The first conductor 121 is shaped like a plate. In the example of FIG. 1, the first conductor 121 is 0.4 mm in thickness and 2 mm in width. The thickness and width of the first conductor 121 are not limited thereto. The first conductor 121 is spaced a distance of a length c1 apart from the ground plate 110 in parallel thereto. The length of the first conductor 121 is expressed as a1+d1. The first conductor 121 is bent at a point at which the entire length is divided into a length a1 and a length d1 at a right angle (90 degrees). The two sides of the first conductor 121 (the side with the length a1 and the side with the length d1) are each parallel to a corresponding side of the ground plate 110. In the example of FIG. 1, although the widthwise direction of the first conductor 121 is perpendicular to the surface of the ground plate 110, the widthwise direction of the first conductor 121 may be parallel to the surface of the ground plate 100. The first conductor 121 may be shape like a bent column or the like.

The second conductor 122 short-circuits the first conductor 121 and the ground plate 110. The second conductor 122 is coupled to the first conductor 121 at a position spaced a predetermined distance f1 apart from the feed point of the first conductor 121. The distance f1 is determined by impedance matching.

The third conductor 123 has the feed point that supplies electric power to the first conductor 121. The third conductor 123 is not coupled, at a position other than a conducting portion via the second conductor 122, to the ground plate 110.

Let an X-axis be an axis of the first conductor 121 parallel to the direction of the length a1, a Y-axis be an axis of the first conductor 121 parallel to the direction of the length d1, and a Z-axis be an axis crossing the X-axis and the Y-axis at right angles, as shown in FIG. 1. The X-axis is parallel to one side of the ground plate 110. The Y-axis is also parallel to one side of the ground plate 110.

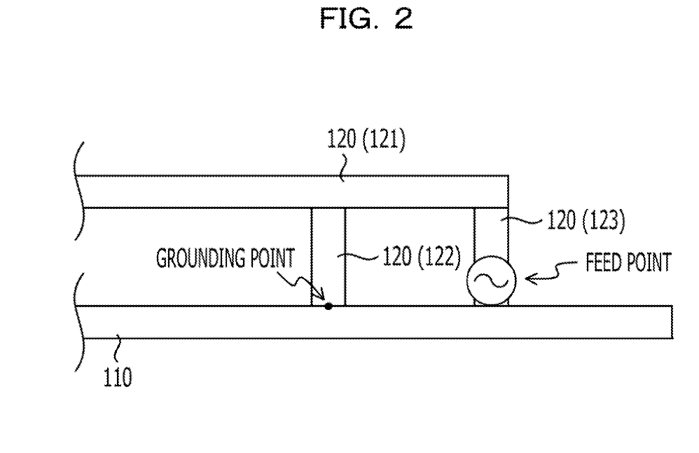

FIG. 2 is a diagram of an example of a plane of the antenna device 100 intersecting the ground plate 110 at right angles and including a grounding point. The ground plate 110 is coupled, at the grounding point, to the second conductor 122 of the radiating conductor 120. The second conductor 122 is coupled to the first conductor 121. The first conductor 121 is coupled to the feeder circuit via the third conductor 123 at the feed point. The antenna device 100 may include the feeder circuit. Substantially the same applies to antenna devices of other embodiments.

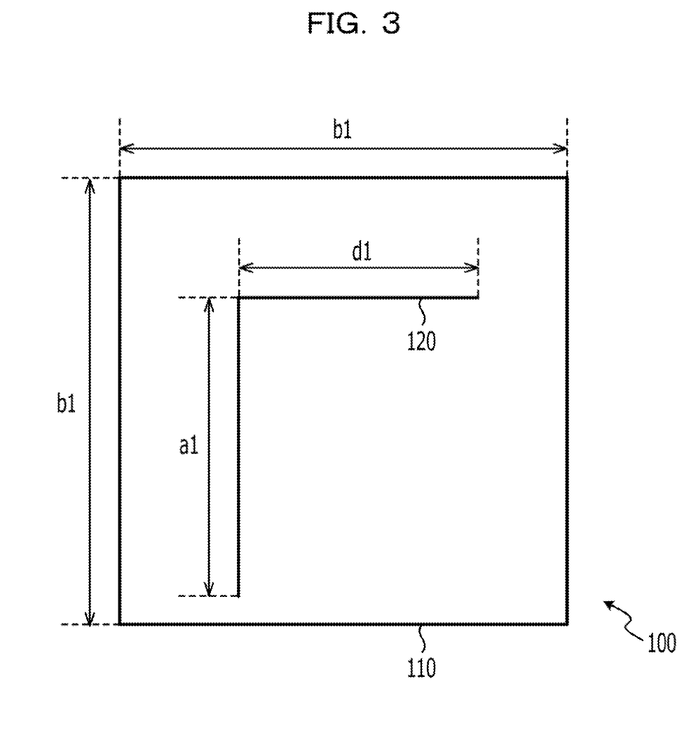

FIG. 3 is a diagram of the antenna device 100 as viewed from the Z-axis direction. The radiating conductor 120 is disposed at a position where it does not protrude from the ground plate 110 as viewed from the Z-axis direction.

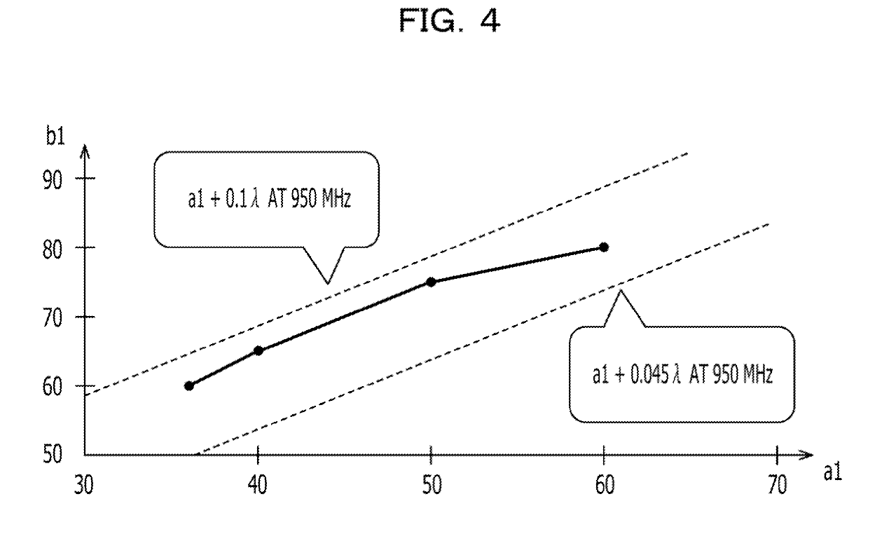

FIG. 4 is a diagram showing an example of the value of the length b1 relative to the length a1 at which the axial ratio of the antenna device 100 (hereinafter referred to as antenna axial ratio) is the minimum. Let λ be the wavelength of electromagnetic waves transmitted and received by the antenna device 100. In the graph in FIG. 4, a frequency used is 950 MHz. A wavelength at a frequency of 950 MHz is 315 mm. At that time, 0.1λ is 32 mm, and 0.045λ is 14 mm.

The antenna axial ratio is the ratio of the electric field intensity in the X-direction of elliptically polarized waves to the electric field intensity in the Y-direction. In the case where the antenna axial ratio is 0 dB, electromagnetic waves output from the antenna is circularly polarized waves. When the antenna axial ratio is 3 dB or lower, electromagnetic waves output from the antenna may be regarded as circularly polarized waves.

In the graph in FIG. 4, in the case where the length b1, which is the length of one side of the ground plate 110, falls between a1+0.045λ and a1+0.1λ, the axial ratio is the minimum. In other words, the optimum value of the length b1 relative to the length a1 falls between a1+0.045λ and a1+0.1λ. Since the first conductor 121 has the bent portion and the ground plate 110 is of this size, an electric current flowing in the ground plate 110 rotates on the ground plate 110 in accordance with the phase of an electric current (transmission signal) flowing in the first conductor 121. Since the electric current flowing in the ground plate 110 rotates on the ground plate 110 in accordance with the phase of the transmission signal, the antenna device 100 exhibits a circular polarization characteristic. The length b1 of one side of the ground plate 110 is 0.34λ at the maximum, and thus, the antenna device 100 can be reduced in size as compared with conventional antennas. On the other hand, if the ground plate 110 is larger than this size, the electric current flowing in the ground plate 110 does not rotate in accordance with the phase of the transmission signal, and thus, the antenna device 100 does not exhibit the circular polarization characteristic.

The sizes of the ground plate 110 and the radiating conductor 120 are set as follows. The sizes set here are merely examples and are not limited thereto.

0.095λ≦a1≦0.24λ

a1+0.045λ≦b1≦a1+0.10λ

c1=2 mm

d1=0.25λ+f1−a1

a1+d1=0.25λ+f1 [Formula 1]

The length of the first conductor 121 is expressed as a1+d1=0.25λ+f1. In the case where the distance f1 between the second conductor 122 and the third conductor 123 is 10 mm, the impedances can be matched.

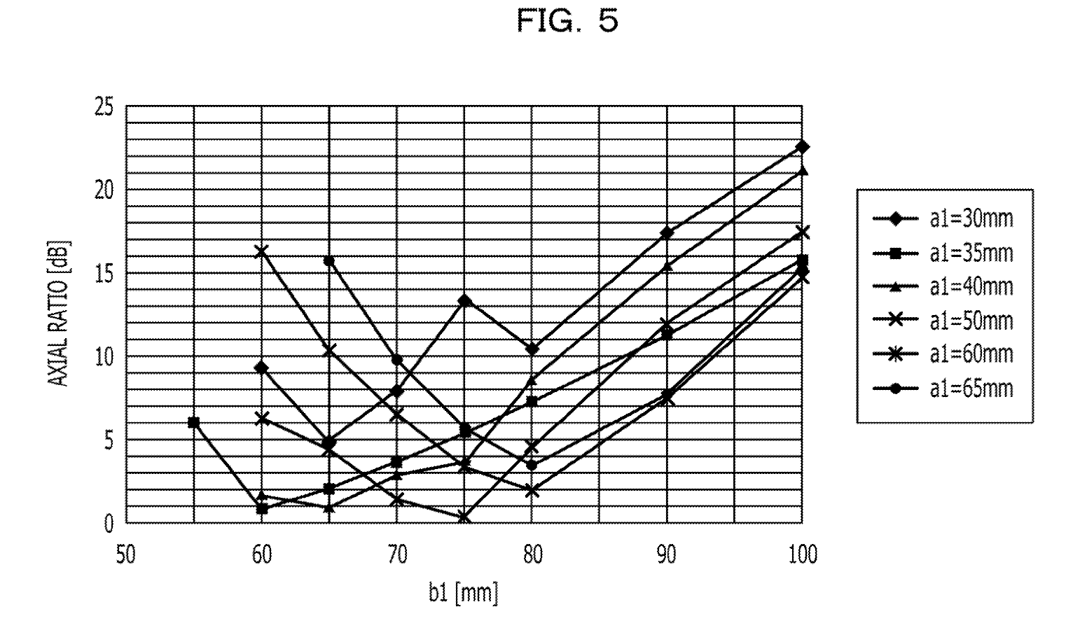

FIG. 5 is a diagram showing an example of a graph of the antenna axial ratio at a frequency of 950 MHz. The graph in FIG. 5 shows antenna axial ratios when the length a1 of the first conductor 121 of the radiating conductor 120 of the antenna device 100 and the length b1 of the ground plate 110 are changed.

In the example of FIG. 5, the antenna axial ratio is the lowest, 0.4 dB, in the case where the length a1=50 mm (=0.159λ) and the length b1=75 mm (=a1+0.08λ). In other words, by setting the sizes of the antenna device 100 to these values, the antenna device 100 exhibits a substantially circular polarization characteristic. Provided that the antenna axial ratio is 3 dB or lower, electromagnetic waves output from the antenna can be regarded as circularly polarized waves, and thus, the antenna device 100 may be of another size at which the antenna axial ratio is 3 dB or lower.

With the configuration shown in FIG. 1, the antenna device 100 has a length and width of 0.34λ or less and a height of 4 mm and exhibits a circular polarization characteristic.

### Configuration Example 1-2

A configuration example 1-2 will be described. The configuration example 1-2 has features in common with the configuration example 1-1. Here, differences are mainly described, and descriptions of the common features are omitted. In the configuration example 1-2, the distance c1 between the first conductor 121 and the ground plate 101 differs from that of the configuration example 1-1.

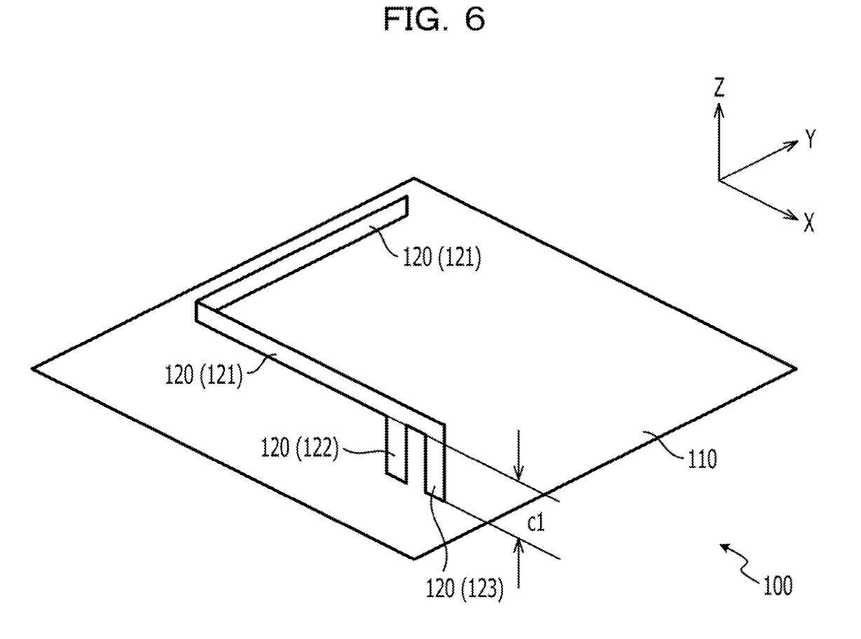

FIG. 6 is a diagram showing an example of an antenna device of the configuration example 1-2. The antenna device 100 of the configuration example 1-1 is configured such that the first conductor 121 is spaced a distance of a length of c1=2 mm apart from the ground plate 101 in parallel thereto, while the length c1 in the configuration example 1-2 is 10 mm.

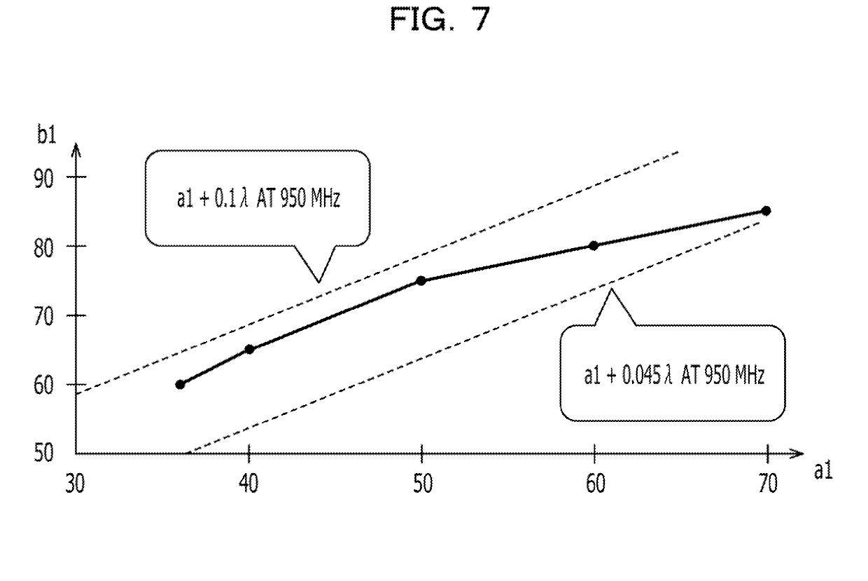

FIG. 7 is a diagram showing an example of the value of the length b1 relative to the length a1 at which the antenna axial ratio is the minimum. In the graph in FIG. 7, a frequency used is 950 MHz. A wavelength at the frequency of 950 MHz is 315 mm. At that time, 0.1λ is 32 mm, and 0.045λ is 14 mm.

In the graph in FIG. 7, in the case where the length b1, which is the length of one side of the ground plate 110, falls between a1+0.045λ and a1+0.1λ, the axial ratio is the minimum. In other words, the optimum value of the length b1 relative to the length a1 is between a1+0.045λ and a1+0.1λ. This is substantially the same as in the configuration example 1-1.

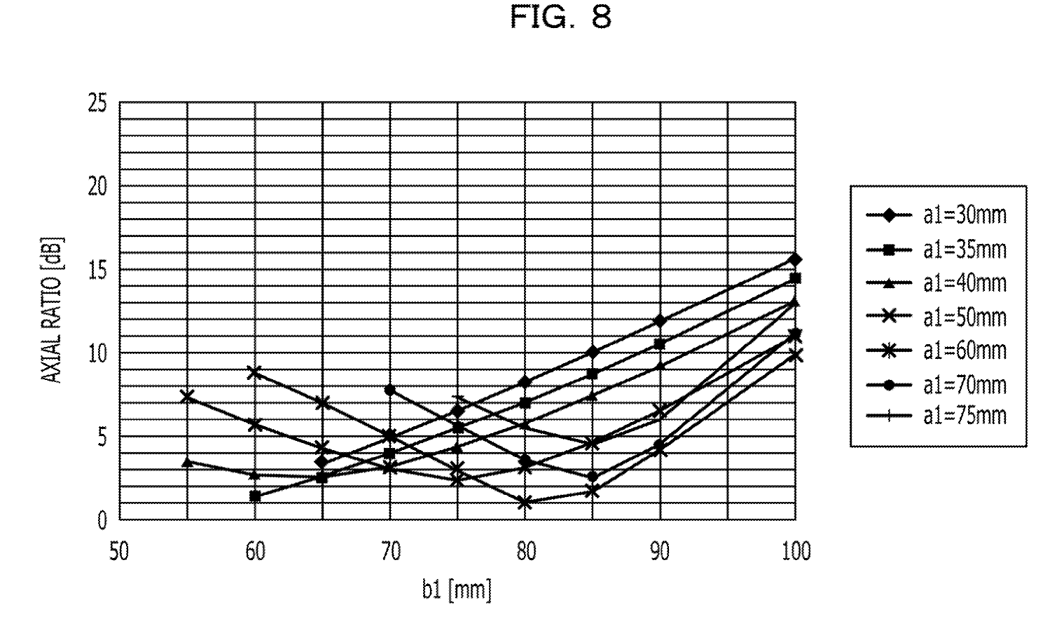

FIG. 8 is a diagram showing an example of a graph of the antenna axial ratio at a frequency of 950 MHz. The graph in FIG. 8 shows antenna axial ratios when the length a1 of the first conductor 121 of the radiating conductor 120 of the antenna device 100 and the length b1 of the ground plate 110 are changed.

In the example of FIG. 8, the antenna axial ratio is the lowest, 1.0 dB, in the case where the length a1=60 mm (=0.190λ) and the length b1=80 mm (=a1+0.06λ). By setting the sizes of the antenna device 100 to these values, the antenna device 100 exhibits a substantially circular polarization characteristic. The antenna device 100 may be of another size at which the axial ratio is 3 dB or lower.

Although increasing the length c1 as in the configuration example 1-2 increases the size of the antenna device 100, characteristics (gain and so on) as an antenna is improved as compared with the configuration example 1-1. The antenna device 100 exhibits a circular polarization characteristic even if the length c1 is increased.

### Operational Advantages of First Embodiment

The antenna device 100 has the bent radiating conductor 120. Since the radiating conductor 120 is bent, the length of one side of the antenna device 100 can be substantially one third or less of the wavelength. Since the radiating conductor 120 is bent, and the ground plate 110 has a predetermined size, the antenna device 100 exhibits a circular polarization characteristic.

Although the conventional inverted-F antenna is smaller than a helical antenna or the like, it has no circular polarization characteristic. With the bent radiating conductor 120 and the ground plate 110 having a predetermined size, the antenna device 100 can be compact and exhibits a circular polarization characteristic.

### Second Embodiment

Next, a second embodiment will be described. The second embodiment has features in common with the first embodiment. Accordingly, differences will be mainly described, and descriptions of the common features will be omitted. In the second embodiment, the ground plate is circular in shape.

### Configuration Example 2-1

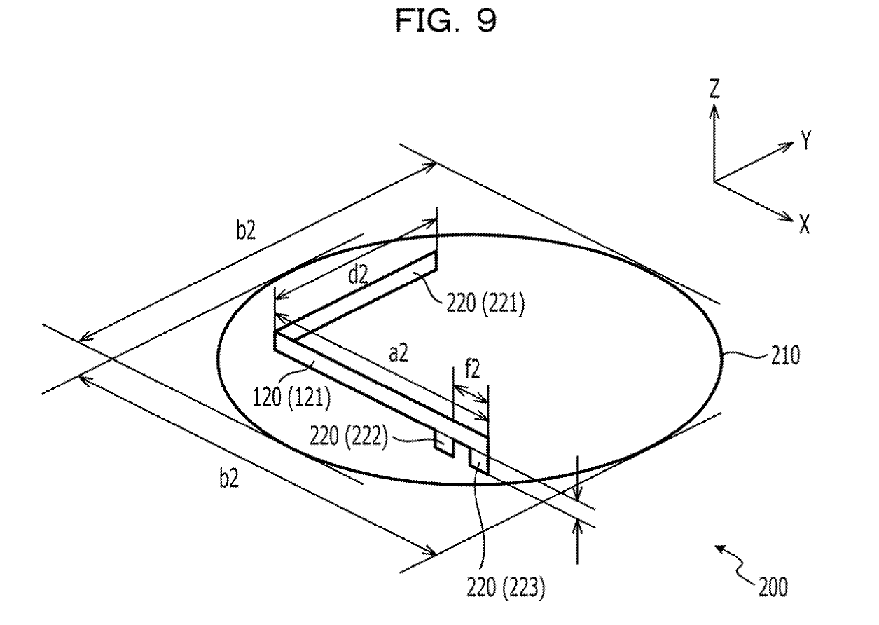

FIG. 9 is a diagram showing an example of an antenna device of a configuration example 2-1. An antenna device 200 includes a ground plate 210 and a radiating conductor 220.

The ground plate 210 is a flat circle with a diameter of a length b2. The ground plate 210 may be a rectangle other than a square or a polygon.

The radiating conductor 220 includes a first conductor 221, a second conductor 222, and a third conductor 223. The radiating conductor 220 has substantially the same configuration as that of the radiating conductor 120 of the first embodiment. The radiating conductor 220 is disposed at a position where it does not protrude from the ground plate 210 as viewed from the Z-axis direction.

The first conductor 221 is spaced a distance of a length c2 apart from the ground plate 210 in parallel thereto. The length of the first conductor 221 is expressed as a2+d2. The first conductor 221 is bent at a point at which the entire length is divided into a length a2 and a length d2 at a right angle (90 degrees).

The second conductor 222 short-circuits the first conductor 221 and the ground plate 210. The second conductor 222 is coupled to the first conductor 221 at a position spaced a predetermined distance f2 apart from the feed point of the first conductor 221. The distance f2 is determined by impedance matching.

When the sizes of the antenna device 200 are set to, for example, a2=50 mm, b2=80 mm, c2=2 mm, d1=39 mm, and f2=10 mm at a frequency of 950 MHz, the axial ratio of the antenna device 200 is 2.67 dB. Since the antenna axial ratio is lower than 3 dB, the antenna device 200 exhibits a circular polarization characteristic. The sizes of the antenna device 200 are not limited thereto.

### Operational Advantages of Second Embodiment

The ground plate 210 of the antenna device 200 is a circle, a rectangle other than a square, or a polygon. The antenna device 200 can exhibit a circular polarization characteristic even if the ground plate 210 is a circle, a rectangle other than a square, or a polygon.

### Third Embodiment

Next, a third embodiment will be described. The third embodiment has features in common with the first and second embodiments. Accordingly, differences will be mainly described, and descriptions of the common features will be omitted. In the third embodiment, the shape of the bending of the radiating conductor is changed.

### Configuration Example 3-1

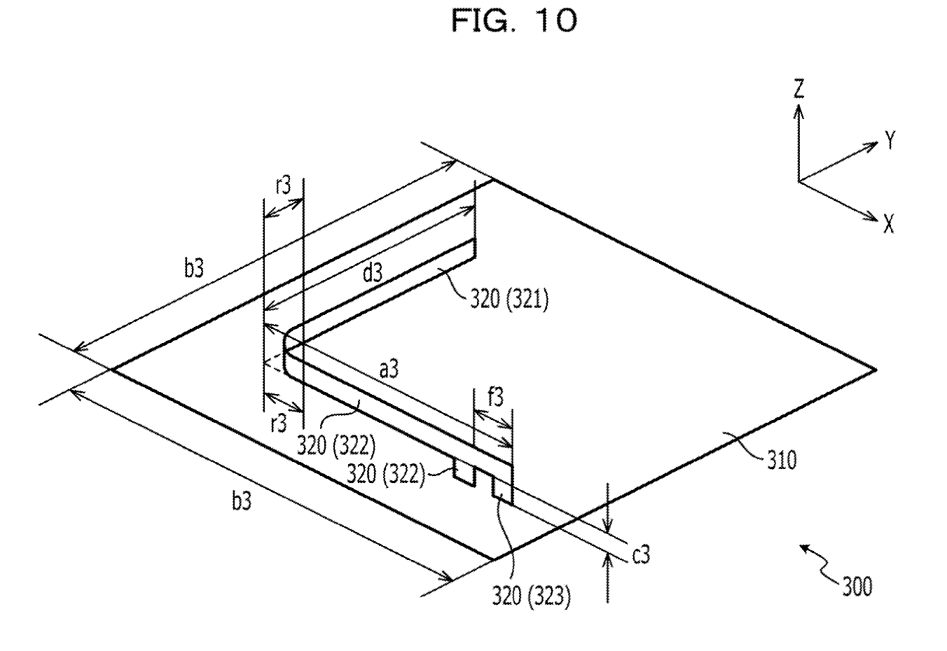

FIG. 10 is a diagram showing an example of an antenna device of a configuration example 3-1. An antenna device 300 includes a ground plate 310 and a radiating conductor 320.

The ground plate 310 is a flat square with a length of b3 on each side. The ground plate 310 has substantially the same configuration as that of the ground plate 110 of the first embodiment. The ground plate 310 may have substantially the same configuration as that of the ground plate 210 of the second embodiment.

The radiating conductor 320 includes a first conductor 321, a second conductor 322, and a third conductor 323. The second conductor 322 and the third conductor 323 have the same configurations as those of the second conductor 122 and the third conductor 123 of the first embodiment, respectively.

The first conductor 321 is spaced a distance of a length c3 apart from the ground plate 310 in parallel thereto. The first conductor 321 is bent at an angle of 90 degrees like an arc with a radius of r3, which corresponds to the perpendicularly bent portion of the first conductor 121 of the first embodiment. Let a length a3 be the length of a portion of the first conductor 321 to the arc portion, which is bent as in the first embodiment, and a length d3 be the length of a portion from the bent portion onward.

The second conductor 322 short-circuits the first conductor 321 and the ground plate 310. The second conductor 322 is coupled to the first conductor 321 at a position spaced a predetermined distance f3 apart from the feed point of the first conductor 321. The distance f3 is determined by impedance matching.

The length a3+d3 of the first conductor 321 may be set to 0.25λ+f3, or alternatively, the length along the straight line portion and the arc portion of the first conductor 321 may be set to 0.25λ+f3.

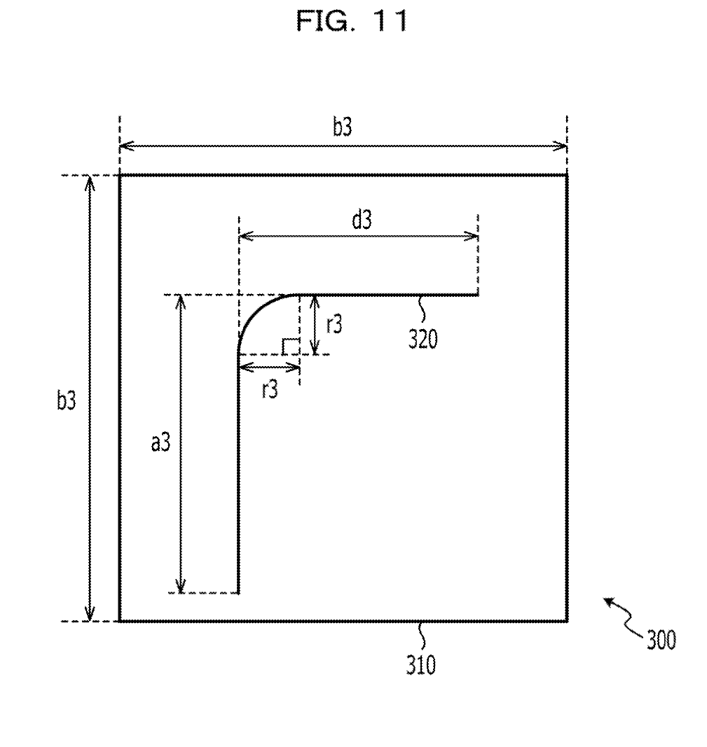

FIG. 11 is a diagram of the antenna device 300 as viewed from the Z-axis direction. The radiating conductor 320 is disposed at a position where it does not protrude from the ground plate 310 as viewed from the Z-axis direction.

When the sizes of the antenna device 300 are set to, for example, a3=50 mm, b3=75 mm, c3=2 mm, d3=42 mm, and f3=10 mm at a frequency of 950 MHz, the axial ratio of the antenna device 300 is 1.25 dB. Since the axial ratio is lower than 3 dB, the antenna device 300 exhibits a circular polarization characteristic. The sizes of the antenna device 300 are not limited thereto.

### Operational Advantages of Third Embodiment

The antenna device 300 is configured such that the bent portion of the radiating conductor 320 is shaped like an arc. The antenna device 300 can exhibit a circular polarization characteristic even if the bent portion of the radiating conductor 320 is shaped like an arc. Since the bent portion of the first conductor 321 is shaped like an arc, the first conductor 321 can be formed more easily than the first conductor 121 of the antenna device 100.

### Fourth Embodiment

Next, a fourth embodiment will be described. The fourth embodiment has features in common with the first to third embodiments. Accordingly, differences will be mainly described, and descriptions of the common features will be omitted. In the fourth embodiment, the shape of the bending of the radiating conductor is changed.

### Configuration Example 4-1

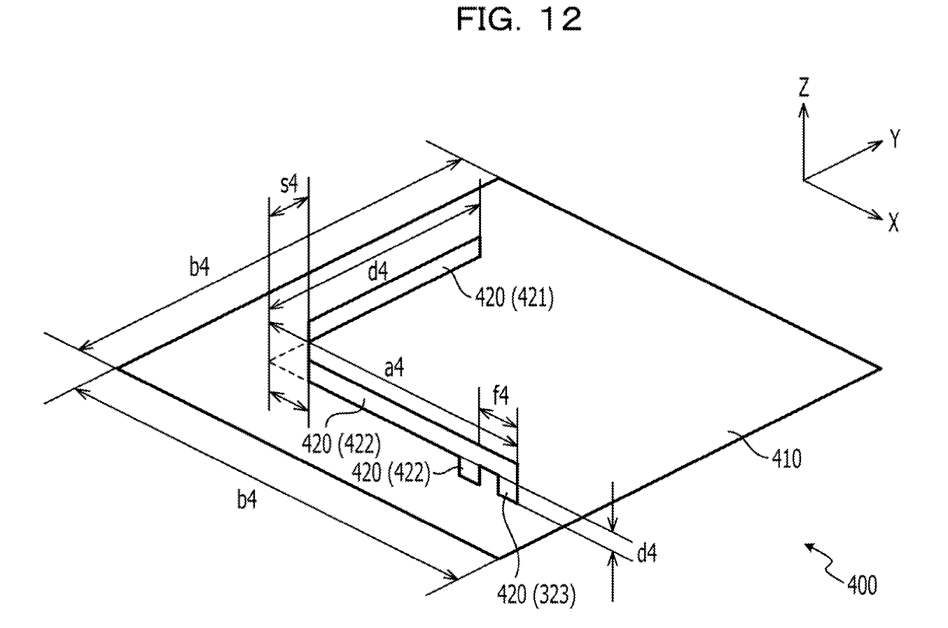

FIG. 12 is a diagram showing an example of an antenna device of a configuration example 4-1. An antenna device 400 includes a ground plate 410 and a radiating conductor 420.

The ground plate 410 is a flat square with a length of b4 on each side. The ground plate 410 has substantially the same configuration as that of the ground plate 110 of the first embodiment. The ground plate 410 may have substantially the same configuration as that of the ground plate 210 of the second embodiment.

The radiating conductor 420 includes a first conductor 421, a second conductor 422, and a third conductor 423. The second conductor 422 and the third conductor 423 have substantially the same configurations as those of the second conductor 122 and the third conductor 123 of the first embodiment, respectively.

The first conductor 421 is spaced a distance of a length c4 apart from the ground plate 410 in parallel thereto. The first conductor 421 is bent twice at an angle of 45 degrees, which corresponds to the perpendicularly bent portion of the first conductor 121 of the first embodiment. Let a length a4 be the length of a portion of the first conductor 421, which is bent twice at an angle of 45 degrees, to a portion, which is bent at right angles in the first embodiment, and let a length d4 be the length of a portion from the bent portion onward. Let a length s4 be the length of s portion cut from the length a4 by bending at 45 degrees. Likewise, the length cut from the length d4 is taken as a length s4. Here, although the first conductor 421 is configured to be bent twice at 45 degrees, it may be bent a plurality of times, finally by 90 degrees, for example, three times at 30 degrees. In the case it is bent a plurality of times, the bending angle may be changed every time it is bent.

The second conductor 422 short-circuits the first conductor 421 and the ground plate 410. The second conductor 422 is coupled to the first conductor 421 at a position spaced a predetermined distance f4 apart from the feed point of the first conductor 421. The distance f4 is determined by impedance matching.

The length a4+d4 of the first conductor 421 may be set to 0.25λ+f4, or alternatively, the length along the first conductor 421 may be set to 0.25λ+f4.

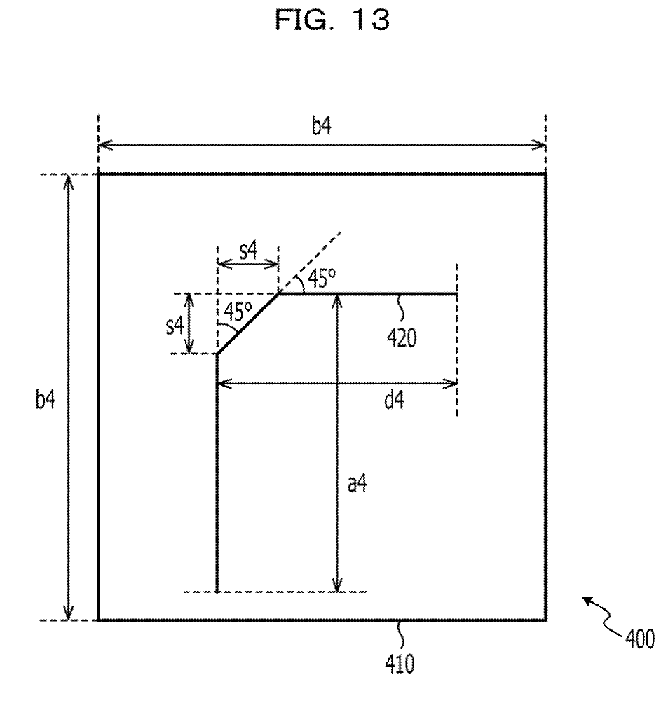

FIG. 13 is a diagram of the antenna device 400 as viewed from the Z-axis direction. The radiating conductor 420 is disposed at a position where it does not protrude from the ground plate 410 as viewed from the Z-axis direction.

When the sizes of the antenna device 400 are set to, for example, a4=50 mm, b4=75 mm, c4=2 mm, d4=44 mm, and f4=10 mm, the axial ratio of the antenna device 400 is 1.54 dB. Since the axial ratio is lower than 3 dB, the antenna device 400 exhibits a circular polarization characteristic. The sizes of the antenna device 400 are not limited thereto.

### Operational Advantages of Fourth Embodiment

The antenna device 400 is configured such that the radiating conductor 420 is bent a plurality of times at an angle smaller than 90 degrees. The antenna device 400 can exhibit a circular polarization characteristic even if the radiating conductor 420 is bent a plurality of times at an angle smaller than 90 degrees. Since the first conductor 421 is bent a plurality of times at an angle smaller than 90 degrees, the first conductor 421 can be formed more easily than the first conductor 121 of the antenna device 100.

### Fifth Embodiment

Next, a fifth embodiment will be described. The fifth embodiment has features in common with the first to fourth embodiments. Accordingly, differences will be mainly described, and descriptions of the common features will be omitted. In the fifth embodiment, the radiating conductor of the antenna device is supported by a dielectric to further reduce the size of the antenna device.

### Configuration Example 5-1

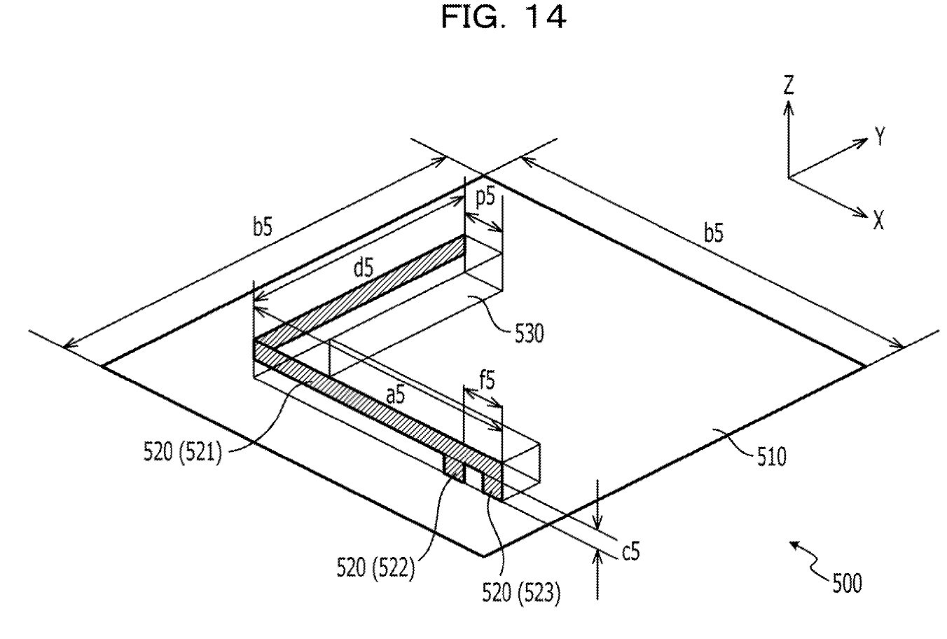

FIG. 14 is a diagram showing an example of an antenna device of a configuration example 5-1. An antenna device 500 includes a ground plate 510, a radiating conductor 520, and a dielectric portion 530.

The ground plate 510 is a flat square with a length of b5 on each side. The ground plate 510 has substantially the same configuration as that of the ground plate 110 of the first embodiment. The ground plate 510 may have substantially the same configuration as that of the ground plate 210 of the second embodiment.

The radiating conductor 520 includes a first conductor 521, a second conductor 522, and a third conductor 523. The second conductor 522 and the third conductor 523 have substantially the same configurations as those of the second conductor 122 and the third conductor 123 of the first embodiment, respectively. The first conductor 521 is spaced a distance of a length c5 apart from the ground plate 510 in parallel thereto. The first conductor 521 is bent at a point at which the entire length is divided into a length a5 and a length d5 at a right angle (90 degrees). The length of the first conductor 521 is expressed as a5+d5. The radiating conductor 520 may have substantially the same configuration as that of the radiating conductor 320 of the third embodiment or the radiating conductor 420 of the fourth embodiment.

The first conductor 521 is shaped like a plate. In the example of FIG. 14, the first conductor 521 is 0.4 mm in thickness and 2 mm in width.

The second conductor 522 short-circuits the first conductor 521 and the ground plate 510. The second conductor 522 is coupled to the first conductor 521 at a position spaced a predetermined distance f5 apart from the feed point of the first conductor 521. The distance f5 is determined by impedance matching.

The dielectric portion 530 is a dielectric that supports the radiating conductor 520. The dielectric portion 530 supports the radiating conductor 520 such that the positional relationship between the radiating conductor 520 and the ground plate 510 is not changed. The antenna device 500 is smaller than the antenna device 100 of the first embodiment owing to the wavelength shortening effect of the dielectric.

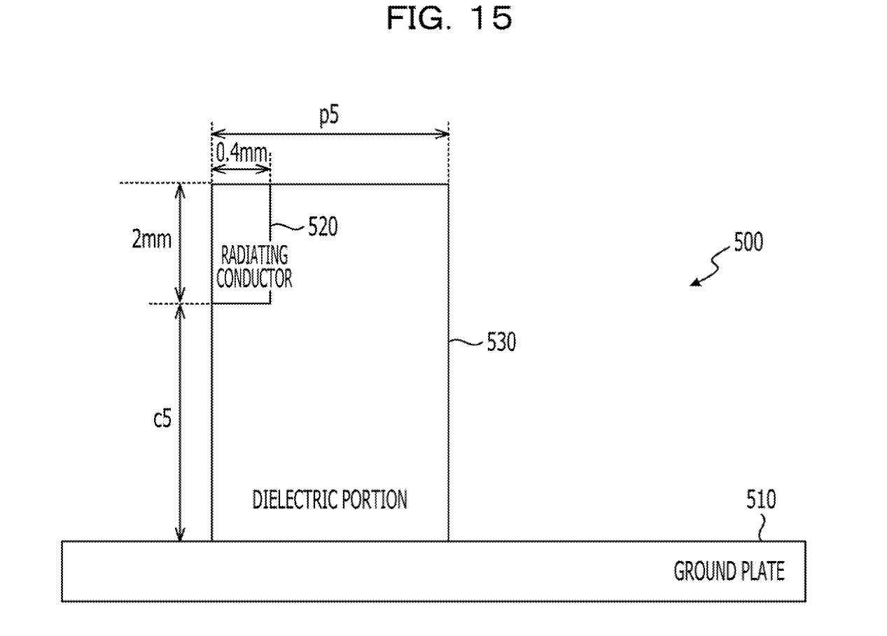

FIG. 15 is a diagram showing an example of the cross section of the dielectric portion 530 and the first conductor 521. The example of FIG. 15 shows a cross section of the antenna device 500 cut along a plane at which the X-axis is a normal so as to pass through the radiating conductor 520. The dielectric portion 530 has a height of 2 mm+c5. The dielectric portion 530 has a width of p5. The shape of the dielectric portion 530 is not limited thereto. The dielectric portion 530 may be large sufficient to support the radiating conductor 520.

For example, a dielectric with a relative dielectric constant (∈r) of 3.7, and tan δ of 0.001 is used as the dielectric of the dielectric portion 530. The width of the dielectric portion is set to p5=1.6 mm. The sizes of the antenna device 200 are set to a5=33.4 mm, b5=47.5 mm, c5=5 mm, d5=28.3 mm, and f5=10 mm at a frequency of 950 MHz. At that time, the axial ratio of the antenna device 500 is 1.2 dB, which is lower than 3 dB, and thus, the antenna device 500 exhibits a circular polarization characteristic. The length (b5) of one side of the antenna device 500 is 37% shorter than the length (b1) of the antenna device 100 of the first embodiment. The area of the ground plate 510 of the antenna device 500 is reduced by 60% as compared with the area of the ground plate 110 of the antenna device 100 of the first embodiment. The sizes of the antenna device 500 are not limited thereto.

### Operational Advantages of Fifth Embodiment

The antenna device 500 supports the radiating conductor 520 with the dielectric portion 530. The sizes of the antenna device 500 can be smaller than a case in which no dielectric is used due to the wavelength shortening effect of the dielectric.

### Sixth Embodiment

Next, a sixth embodiment will be described. The sixth embodiment has features in common with the first to fifth embodiments. Accordingly, differences will be mainly described, and descriptions of the common features will be omitted. In the sixth embodiment, the antenna device is provided with two radiating conductors so that the peak of the gain is directed in the +Z-direction.

### Configuration Example 6-1

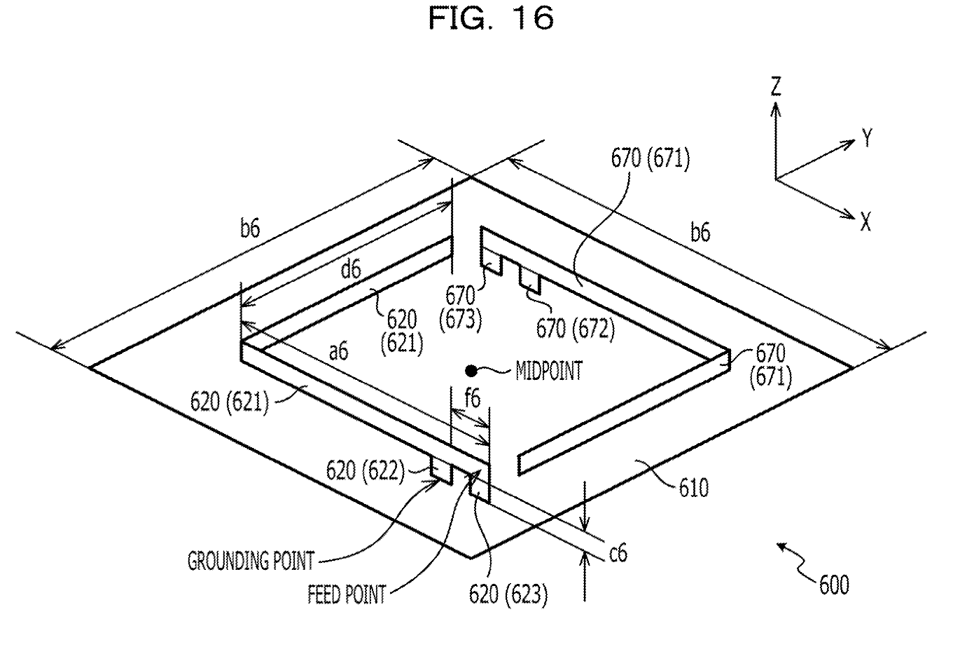

FIG. 16 is a diagram showing an example of an antenna device of a configuration example 6-1. An antenna device 600 includes a ground plate 610, a first radiating conductor 620, and a second radiating conductor 670.

The ground plate 610 is a flat square with a length of b6 on each side. The ground plate 610 has substantially the same configuration as that of the ground plate 110 of the first embodiment. The ground plate 610 may have substantially the same configuration as that of the ground plate 210 of the second embodiment.

The first radiating conductor 620 includes a first conductor 621, a second conductor 622, and a third conductor 623. The radiating conductor 620 has substantially the same configuration as that of the radiating conductor 120 of the first embodiment. The first radiating conductor 620 is disposed at a position where it does not protrude from the ground plate 610 as viewed from the Z-axis direction.

The first conductor 621 is spaced a distance of a length c6 apart from the ground plate 610 in parallel thereto. The length of the first conductor 621 is expressed as a6+d6. The first conductor 621 is bent at a point at which the entire length is divided into a length a6 and a length d6 at a right angle (90 degrees).

The second conductor 622 short-circuits the first conductor 621 and the ground plate 610. The second conductor 622 is coupled to the first conductor 621 at a position a predetermined distance f6 apart from the feed point of the first conductor 621. The distance f6 is determined by impedance matching.

The third conductor 623 connects the feed point of the first conductor 622 and a feeder circuit. The third conductor 623 is not directly electrically coupled to the ground plate 610.

The second radiating conductor 670 includes a first conductor 671, a second conductor 672, and a third conductor 673. The second radiating conductor 670 has substantially the same configuration as that of the first radiating conductor 620. The second radiating conductor 670 has substantially the same size as that of the first radiating conductor 620. The second radiating conductor 670 is disposed at a position where it does not protrude from the ground plate 670 as viewed from the Z-axis direction. The second radiating conductor 670 is disposed at a position symmetric with respect to the first radiating conductor 620 about the midpoint of the ground plate 610.

The first radiating conductor 620 and the second radiating conductor 670 may have substantially the same configuration as that of the radiating conductor 320 of the third embodiment or the radiating conductor 420 of the fourth embodiment.

The antenna device 600 may be provided with a dielectric portion as in the case of the antenna device 500. Providing the dielectric portion can reduce the size of the antenna device 600.

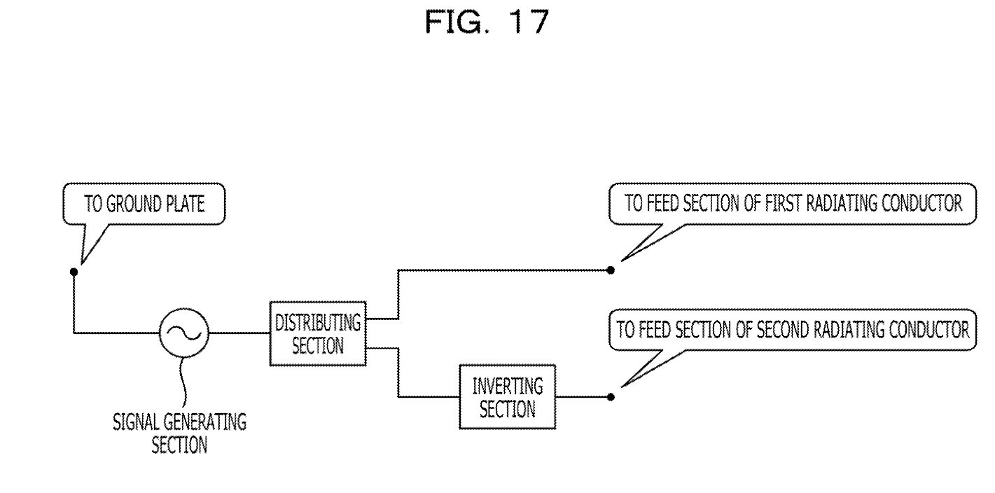

FIG. 17 is a diagram for explaining the feeder circuit coupled to the antenna device 600. The feeder circuit includes a signal generating section, a distributing section, and an inverting section. The signal generating section generates a radio signal to be output from the antenna. The distributing section divides the signal generated by the signal generating section into two signals. The inverting section inverts one of the signals input from the distributing section through 180 degrees.

The signal generated by the signal generating section of the feeder circuit is divided into two signals by the distributing section. One of the signals is directly input to the feed point of the first radiating conductor 620. The other signal is inverted 180 degrees by the inverting section and is then input to the feed point of the second radiating conductor 670. In other words, the first radiating conductor 620 and the second radiating conductor 670 receive signals different in phase by 180 degrees. The antenna device 600 may include the feeder circuit in FIG. 17.

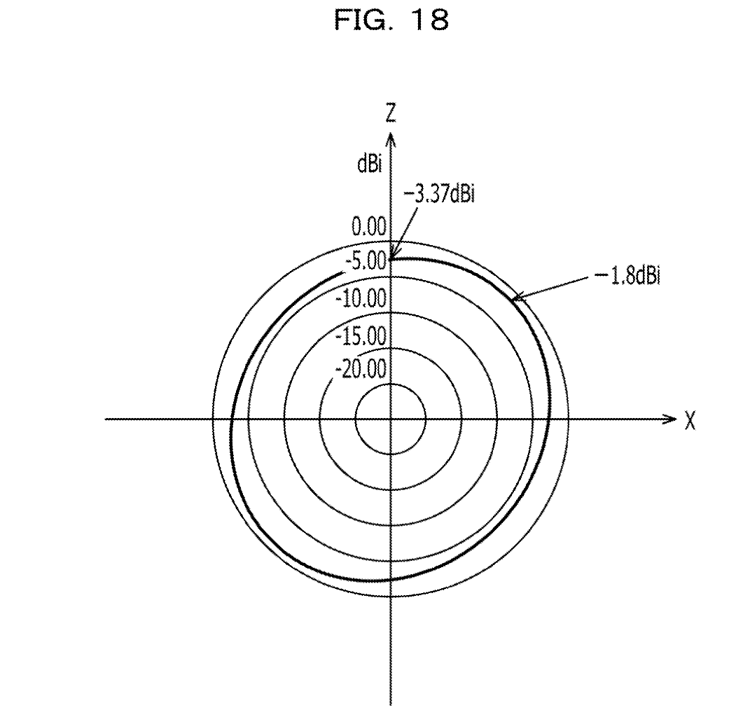

FIG. 18 is a diagram showing an example of a gain in the X-Z plane of the antenna device 100 of the first embodiment. The gain of the antenna device 100 has its peak, not in the +Z-direction, but in a direction shifted about 45 degrees from the +Z-direction.

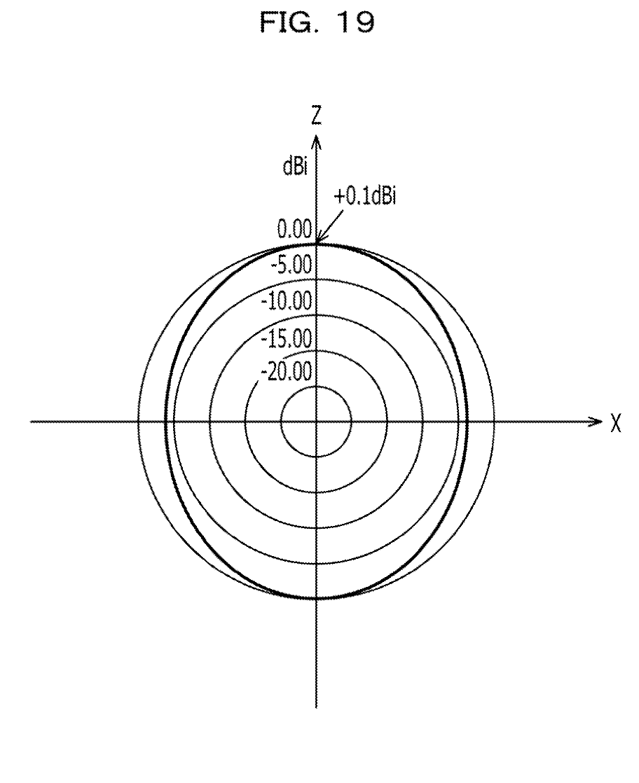

FIG. 19 is a diagram showing an example of a gain in the X-Z plane of the antenna device 600 of the sixth embodiment. The gain of the antenna device 600 has a peak in the +Z-direction. Accordingly, by providing two radiating conductors as in the antenna device 600, the peak of the gain of the antenna can be directed to the +Z-direction. In other words, the direction of the maximum gain of the antenna device 600 is normal to the ground plate 610.

### Operational Advantages of Sixth Embodiment

The two radiating conductors 620 and 670 of the antenna device 600 receive signals different in phase by 180 degrees from the feeder circuit. The antenna device 600 has the radiating conductors 620 and 670 symmetric about the midpoint of the ground plate 610. The maximum gain of the antenna device 600 can be directed normal to the ground plate 610.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention. All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. An antenna device comprising:
a ground plate;
a feed section insulated from the ground plate;
two radiating conductors each coupled to a corresponding short-circuit section coupled to the feed section and the ground plate, extending in parallel to the ground plate, and spaced a predetermined distance apart from the ground plate; and
a feeder circuit that supplies electric power to the radiating conductors,
the two radiating conductors are disposed symmetrically about the point on the ground plate;
the feeder circuit supplies electric power in opposite phases to the two radiating conductors; and
the two radiating conductors have bent portions of the same form.

2. The antenna device according to claim 1, wherein
the bending angle of the bent portions is 90 degrees.

3. The antenna device according to claim 1, wherein
the bent portions are shaped like an arc.

4. The antenna device according to claim 1, wherein
the bent portions are bent a plurality of times at an angle less than 90 degrees.

5. The antenna device according to claim 1, wherein
the ground plate is square in shape.

6. The antenna device according to claim 2, wherein
the ground plate is square in shape.

7. The antenna device according to claim 3, wherein
the ground plate is square in shape.

8. The antenna device according to claim 4, wherein
the ground plate is square in shape.

9. The antenna device according to claim 1, wherein
the ground plate is circular in shape.

10. The antenna device according to claim 2, wherein
the ground plate is circular in shape.

11. The antenna device according to claim 3, wherein
the ground plate is circular in shape.

12. The antenna device according to claim 4, wherein
the ground plate is circular in shape.

13. The antenna device according to claim 1, further comprising:
a dielectric portion that supports a corresponding one of the radiating conductors.

14. The antenna device according to claim 2, further comprising:
a dielectric portion that supports a corresponding one of the radiating conductors.

15. The antenna device according to claim 3, further comprising:
a dielectric portion that supports a corresponding one of the radiating conductors.

16. The antenna device according to claim 4, further comprising:
a dielectric portion that supports a corresponding one of the radiating conductors.

17. The antenna device according to claim 5, further comprising:
a dielectric portion that supports a corresponding one of the radiating conductors.

18. The antenna device according to claim 6, further comprising:
a dielectric portion that supports a corresponding one of the radiating conductors.
